(19) United States
(12) Patent Application Publication
(10) Pub. No.: US 2026/0273931 A1
(43) Pub. Date: Sep. 17, 2026

(54) DRIVING DEVICE, LIQUID EJECTION HEAD, AND LIQUID EJECTION DEVICE

(71) Applicant: RISO Technologies Corporation, Tokyo (JP)

(72) Inventor: Masaya ICHIKAWA, Mishima Shizuoka (JP)

(21) Appl. No.: 19/450,660

(22) Filed: Jan. 15, 2026

(30) Foreign Application Priority Data
Mar. 14, 2025 (JP) 2025-041499

(51) Int. Cl. B41J 2/045

(52) U.S. Cl. CPC B41J 2/04588; B41J 2/04541; B41J 2/04581

(57) ABSTRACT

A driving device for a liquid ejection head including an actuator configured to eject liquid stored in a pressure chamber through a nozzle, includes a drive circuit configured to generate a drive signal for the actuator of the liquid ejection head, the drive signal including one or more drop waveforms for ejecting one or more droplets of the liquid through the nozzle. The drive circuit is further configured to arrange the one or more drop waveforms in a rear-justified manner such that an end timing of a final drop waveform is the same among drive waveforms for ejecting different numbers of droplets.

### CROSS-REFERENCE TO RELATED APPLICATION

This application is based upon and claims the benefit of priority from Japanese Patent Application No. 2025-041499, filed on March 14, 2025, the entire contents of which are incorporated herein by reference.

### FIELD

Embodiments described herein relate generally to a driving device, a liquid ejection head, and a liquid ejection device.

### BACKGROUND

Multi-drop driving is known as one of the ejection controls of a liquid ejection device such as an inkjet head. A waveform of multi-drop driving is a waveform that repeats actuator operations of expansion, steady state, contraction, and steady state. That is, the number of droplets can be adjusted by the number of repetitions of the ejection operation, and a volume of the droplet can be controlled.

For example, if an ejection waveform for ejecting one droplet is a drop waveform having one positive pulse and one negative pulse, an ejection waveform for ejecting a plurality of drops is a waveform including this basic drop waveform provided consecutively for the number of droplets.

In such multi-drop driving, it is required to improve landing accuracy.

### BRIEF DESCRIPTION OF THE DRAWINGS

FIG. 1 is a diagram illustrating a liquid ejection device according to a first embodiment.

FIG. 2 is a perspective view illustrating a liquid ejection head.

FIG. 3 is a waveform diagram illustrating drive waveforms of a plurality of drops.

FIG. 4 is a diagram illustrating a drive waveform of five drops.

FIG. 5 is a diagram illustrating an example of a plurality of drive patterns.

FIG. 6 is a diagram illustrating drive timing of a pattern 1.

FIG. 7 is a diagram illustrating drive timing of a pattern 2.

FIG. 8 is a diagram illustrating drive timing of a pattern 3.

FIG. 9 is a diagram illustrating a landing image formed by the liquid ejection head.

FIG. 10 is a waveform diagram illustrating drive waveforms of a plurality of drops according to another embodiment.

FIG. 11 is a diagram illustrating an example of a plurality of drive patterns according to Comparative Example 1.

FIG. 12 is a diagram illustrating drive timing of the pattern 1 of a liquid ejection head.

FIG. 13 is a diagram illustrating drive timing of the pattern 2.

FIG. 14 is a diagram illustrating drive timing of the pattern 3.

FIG. 15 is a diagram illustrating a landing image formed by the liquid ejection head.

FIG. 16 is a diagram illustrating frequency dependence in a multi-drop waveform.

### DETAILED DESCRIPTION

Embodiments of the present disclosure provide a driving device, a liquid ejection head, and a liquid ejection device capable of improving landing accuracy.

In general, according to one embodiment, a driving device for a liquid ejection head including an actuator configured to eject liquid stored in a pressure chamber through a nozzle, comprises a drive circuit configured to generate a drive signal for the actuator of the liquid ejection head, the drive signal including one or more drop waveforms for ejecting one or more droplets of the liquid through the nozzle. The drive circuit is further configured to arrange the one or more drop waveforms in a rear-justified manner such that an end timing of a final drop waveform is the same among drive waveforms for ejecting different numbers of droplets.

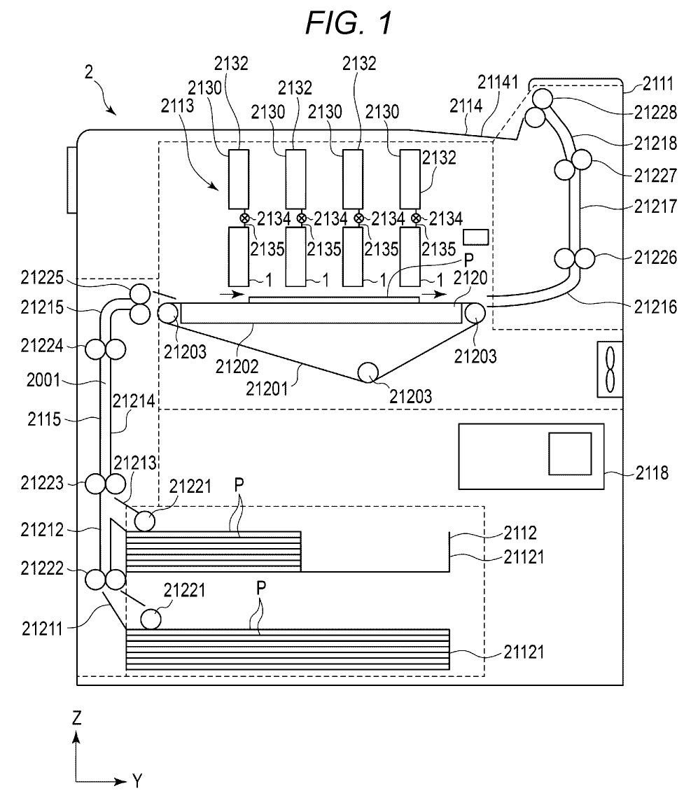

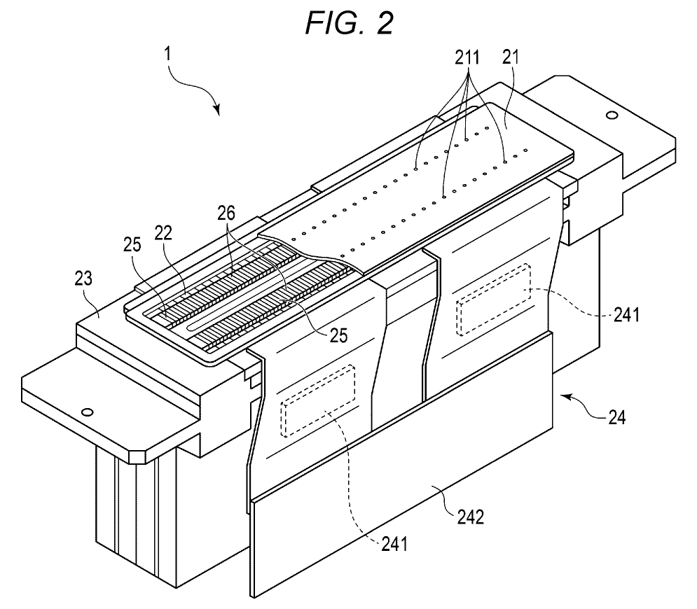

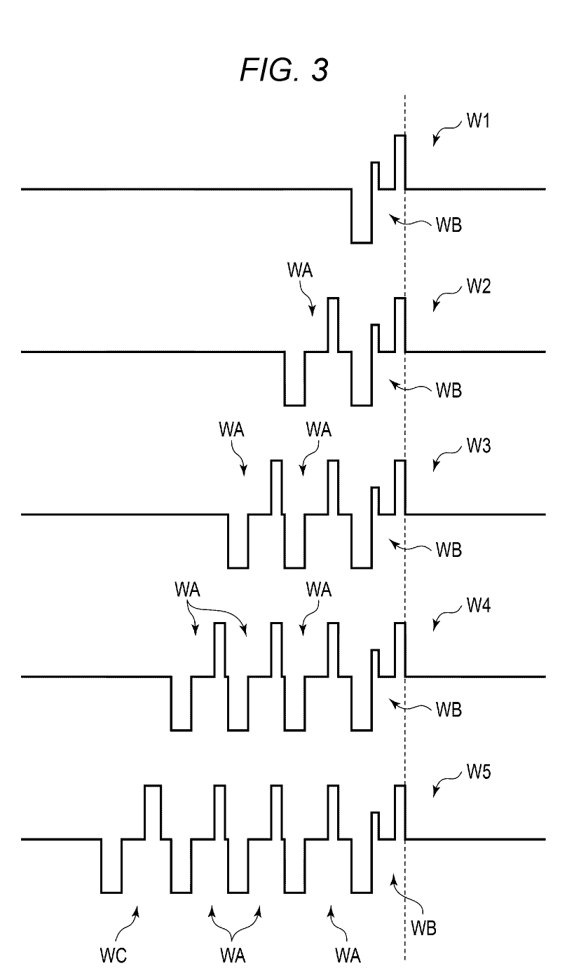

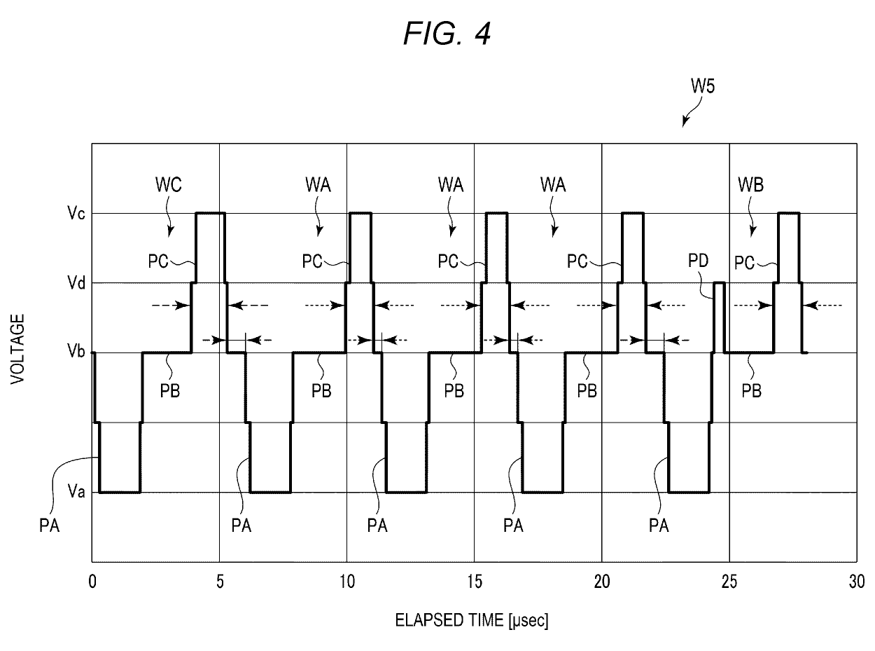

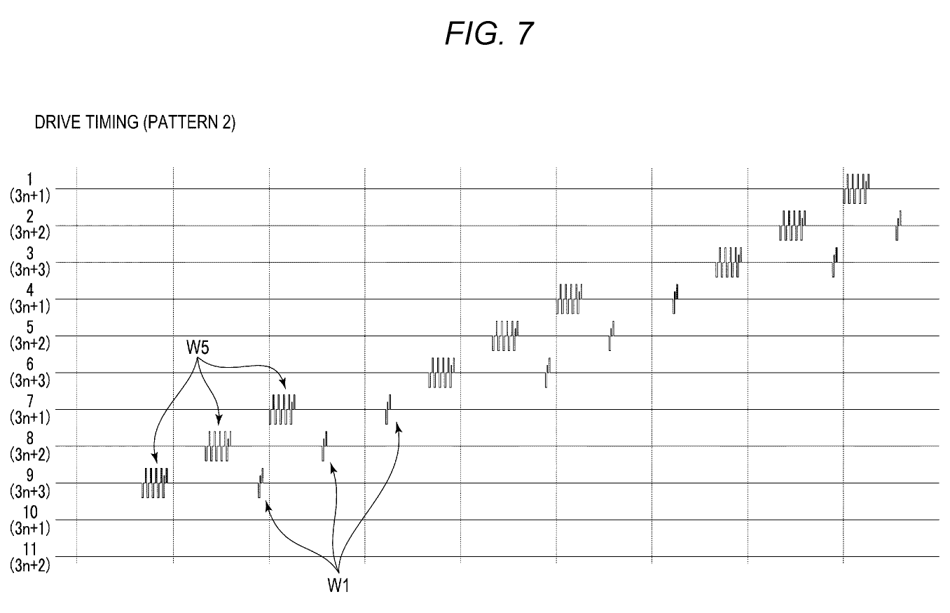

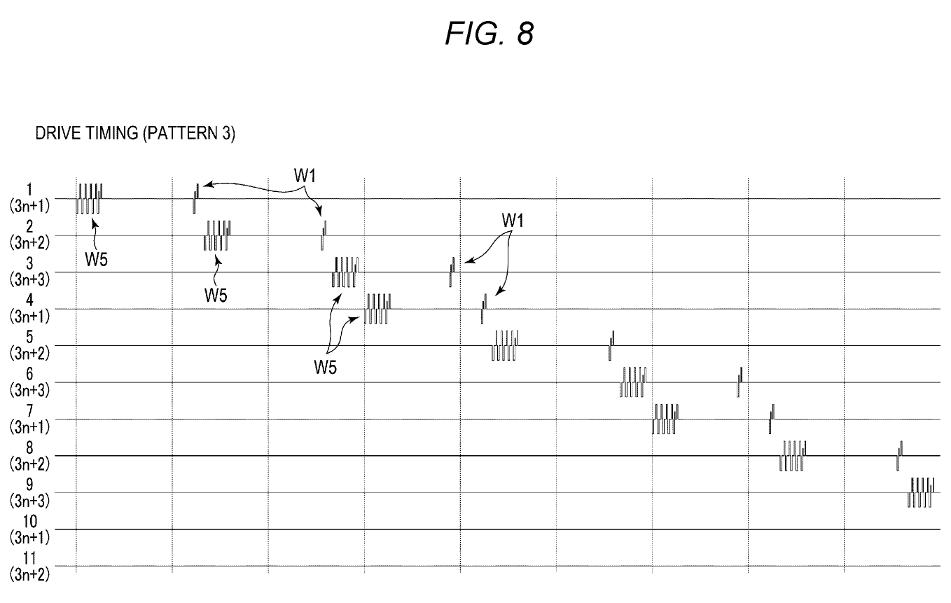

Hereinafter, as an example of a driving device according to a first embodiment, a liquid ejection head 1 and a liquid ejection device 2 using the liquid ejection head 1 will be described with reference to FIGS. 1-9. FIG. 1 is a diagram illustrating the liquid ejection device 2 according to the first embodiment, and FIG. 2 is a perspective view illustrating the liquid ejection head 1. FIG. 3 is a waveform diagram illustrating a multi-drop waveform in the first embodiment, and FIG. 4 is a waveform diagram illustrating ejection waveforms of a plurality of drops. In the drawings, configurations are illustrated in an enlarged, reduced, or omitted manner as appropriate for the purpose of description.

The liquid ejection device 2 including the liquid ejection head 1 will be described with reference to FIG. 1. The liquid ejection device 2 includes a housing 2111, a medium supply unit 2112, an image forming unit 2113, a medium discharge unit 2114, a conveyance device 2115 which is a support device, and a control unit 2118.

The liquid ejection device 2 is an inkjet printer that performs image formation processing on paper P by ejecting a liquid such as ink while conveying, for example, the paper P as a recording medium, which is an ejection target, along a predetermined conveying path 2001 from the medium supply unit 2112 through the image forming unit 2113 to the medium discharge unit 2114.

The medium supply unit 2112 includes a plurality of paper supply cassettes 21121. The image forming unit 2113 includes a support portion 2120 that supports paper, and a plurality of head units 2130 disposed above and facing the support portion 2120. The medium discharge unit 2114 includes a paper discharge tray 21141.

The support portion 2120 includes a conveying belt 21201 provided in a loop shape in a predetermined area where image formation is performed, a support plate 21202 that supports the conveying belt 21201 from the back side, and a plurality of belt rollers 21203 provided on the back side of the conveying belt 21201.

The head unit 2130 includes a plurality of liquid ejection heads 1 as inkjet heads, a plurality of supply tanks 2132 as liquid tanks mounted on the respective liquid ejection heads 1, a pump 2134 that supplies ink, and a connection flow path 2135 that connects the liquid ejection heads 1 and the supply tanks 2132.

The liquid ejection head 1 is supplied with ink as a liquid stored in the supply tank 2132. The liquid ejection head 1 may be a non-circulation type head that does not circulate ink, or may be a circulation type head that circulates ink.

In the present embodiment, as the liquid ejection head 1, liquid ejection heads 1 of four colors of cyan, magenta, yellow, and black, and the supply tanks 2132 of four colors for storing inks of the respective colors are provided. The supply tanks 2132 are connected to the liquid ejection head 1 by the connection flow path 2135.

As illustrated in FIG. 2, the liquid ejection head 1 is an inkjet head, and includes a nozzle plate 21 having a plurality of nozzles 211, an actuator substrate 22, a manifold 23 bonded to the actuator substrate 22, and a drive circuit 24 (drive unit).

The actuator substrate 22 includes actuators 25 as liquid ejection units that are disposed to face the nozzles 211 and each include a plurality of pressure chambers 26 communicating with the nozzles 211 and a drive element unit adjacent to the plurality of pressure chambers 26. The actuator substrate 22 is formed in a predetermined shape that forms a predetermined flow path including the plurality of pressure chambers 26 between the actuator substrate 22 and the nozzle plate 21.

An electrode connected to the drive circuit 24 is formed on the drive element unit adjacent to the pressure chambers 26 of the actuators 25. The electrode is connected to the control unit 2118 via a driver (to be described later) of the drive circuit 24 by, for example, wiring connected to the drive circuit 24, and is driven and controlled by control of a processor.

The drive circuit 24 includes driver ICs 241 and various wiring boards 242. For example, the drive circuit 24 drives the actuators 25 by applying a drive voltage to a wiring pattern of the actuators 25 using the driver ICs 241, thereby increasing or decreasing the volume of the pressure chambers 26, and ejecting droplets from the nozzles 211 disposed to face the pressure chambers 26.

In the liquid ejection head 1, the nozzle plate 21, the actuator substrate 22, and the manifold 23 form a predetermined flow path including the pressure chambers 26. The flow path of the liquid ejection head 1 is connected to the connection flow path 2135 of the liquid ejection device. For example, the liquid ejection head 1 is a shear mode type inkjet head.

The pump 2134 is, for example, a liquid feed pump formed of a piezoelectric pump. The pump 2134 is connected to the control unit 2118 and is driven and controlled by the control unit 2118.

The connection flow path 2135 includes a supply flow path connected to an ink supply pipe of the liquid ejection head 1. The connection flow path 2135 includes a collection flow path connected to an ink discharge pipe of the liquid ejection head 1. For example, if the liquid ejection head 1 is of a non-circulation type, the collection flow path is connected to a maintenance device. If the liquid ejection head 1 is of a circulation type, the collection flow path is connected to the supply tank 2132.

The conveyance device 2115 conveys the paper P along the conveying path 2001 from the paper supply cassette 21121 of the medium supply unit 2112 through the image forming unit 2113 to the paper discharge tray 21141 of the medium discharge unit 2114. The conveyance device 2115 includes a plurality of guide plate pairs 21211 to 21218 disposed along the conveying path 2001 and a plurality of conveyance rollers 21221 to 21228. The conveyance device 2115 supports the paper P movably with respect to the liquid ejection head 1.

The control unit 2118 is, for example, a control board. The control unit 2118 includes a processor, a read only memory (ROM), a random access memory (RAM), an I/O port which is an input and output port, and an image memory.

The processor is a processing circuit such as a central processing unit (CPU) which is a controller. The processor controls, through the I/O port, the head unit 2130, a drive motor, an operation unit, various sensors, and the like that are provided in the liquid ejection device 2. The processor transmits printing data stored in the image memory to the drive circuit 24 in a drawing order.

The control unit 2118 determines an adjustment drop waveform based on adjustment data. For example, an adjustment drop waveform to be applied is selected from among adjustment drop waveforms that can be set in a plurality of stages.

The ROM stores various programs. The RAM temporarily stores various types of variable data, image data, and the like. The I/O port is an interface unit that receives data from the outside and outputs data to the outside. The printing data from an externally connected device is transmitted to the control unit 2118 through the I/O port, and is stored in the image memory.

The printing data is data to be input to a head, which is converted from image data including information on color and density of each area, or the like for ejecting a liquid. The liquid ejection head 1 selects a drive waveform according to the printing data and applies the drive waveform to the actuators 25.

Hereinafter, characteristics of the liquid ejection head 1 used in the liquid ejection device 2 and a drive waveform according to the drive signal generated by the drive circuit 24 of the liquid ejection head 1 will be described. For example, the liquid ejection head 1 is of a multi-drop drive type, and can be driven in a plurality of gradations by combining a plurality of drop waveforms including a standard drop waveform and an adjustment drop waveform. That is, the drive circuit 24 drives the actuators with a multi-gradation drive waveform using multi-drop signals having a plurality of patterns (types).

The control unit 2118 sets, based on the printing data, a drive waveform to be applied to each drive element. For example, the control unit 2118 sets a combination of the adjustment drop waveform and the standard drop waveform based on the printing data. As a specific example, the control unit 2118 selects a drive pattern for each element from among a plurality of patterns set and stored in advance. Also, the control unit 2118 sets an adjustment amount of the adjustment drop waveform for each nozzle.

For example, the control unit 2118 drives, based on the printing data, a plurality of drive elements corresponding to the respective nozzles of the liquid ejection unit with a plurality of multi-waveform patterns including a standard drop waveform, an adjustment drop waveform, and a non-ejection waveform.

FIG. 3 is a diagram illustrating a drive waveform of each drop according to the present embodiment. FIG. 3 illustrates a drive waveform illustrating an ejection waveform of each drop when one or a plurality of drops are ejected. FIG. 4 is a graph illustrating an example of a drive waveform in the present embodiment when five drops are ejected. As illustrated in FIGS. 3 and 4, the present embodiment uses a drive waveform including a maximum number of drop waveforms (elements) of five within one printing cycle. In each drawing, a vertical axis represents a voltage [V], and a horizontal axis represents a time [μs].

The multi-drop drive waveform according to the present embodiment is a waveform that repeats actuator operations of expansion, steady state, contraction, and steady state. For example, the drive waveform includes a plurality of drop waveforms, and is formed by combining one or a plurality of a standard drop waveform WA, a final drop waveform WB, and a leading drop waveform WC.

A drive waveform W1 for ejecting one drop is a waveform including one final drop waveform WB.

A drive waveform W2 for ejecting two drops is a waveform including the final drop waveform WB and one standard drop waveform WA disposed before the final drop waveform WB.

A drive waveform W3 for ejecting three drops and a drive waveform W4 for ejecting four drops are waveforms including the final drop waveform WB, one or a plurality of standard drop waveforms WA before the final drop waveform WB, and the first drop waveform WC.

Here, as illustrated in FIGS. 3 and 4, the standard drop waveform WA includes an expansion element PA (expansion waveform portion) which is a pulse waveform, a steady element PB (steady waveform portion), and a contraction element PC (contraction waveform portion) which is a pulse waveform. That is, the standard drop waveform WA is a waveform for ejecting one droplet from the pressure chamber through an expansion state, a steady state, and a contraction state.

In the multi-drop drive waveform of the present embodiment, in a plurality of drop waveforms in a maximum drop drive waveform for driving a maximum number of drops of three or more, the first leading drop waveform WC and the last final drop waveform WB have characteristics different from those of the intermediate standard drop waveform WA.

For example, as illustrated in FIG. 3, a width of the contraction waveform portion of the first leading drop waveform WC is longer than widths of the contraction waveform portions of the other drop waveforms WB and WA.

As illustrated in FIG. 3, a time interval between a leading drop waveform for ejecting a first droplet and a standard drop waveform for ejecting a second droplet and a time interval between a final drop waveform and a drop waveform before the final drop waveform are set longer than a time interval between the other standard drop waveforms.

As illustrated in FIG. 4, the standard drop waveform WA includes the expansion element PA which is a pulse waveform for ejecting ink by decreasing the voltage from an intermediate voltage Vb to an expansion voltage Va to expand the pressure chamber 26 and then returning the voltage to the intermediate voltage Vb after a certain time elapses, the steady element PB for maintaining the intermediate voltage Vb for a certain time, and the contraction element PC which is a pulse waveform for increasing the voltage from the intermediate voltage Vb to a contraction voltage Vc higher than the expansion voltage Va and the intermediate voltage Vb to contract the pressure chamber 26 and then returning the voltage to the intermediate voltage Vb again. For example, the intermediate voltage Vb is 0 V.

A pulse width of the expansion element PA in the standard drop waveform WA is set to an acoustic length (AL), which is half the natural vibration period of the pressure chamber 26 of the liquid ejection head 1.

As an example, the standard drop waveform WA is a step waveform for increasing or decreasing the voltage in stages when increasing and decreasing the voltage during expansion and contraction, but is not limited thereto, and may be a waveform for increasing or decreasing the voltage at one time.

The final drop waveform WB includes the expansion element PA, an auxiliary contraction element PD (small contraction waveform portion), the steady element PB, and the contraction element PC. That is, the final drop waveform WB is a waveform for ejecting one droplet from the pressure chamber through an expansion state, an auxiliary contraction state, a steady state, and a contraction state.

The final drop waveform WB includes the expansion element PA which is a pulse waveform for ejecting ink by decreasing the voltage from the intermediate voltage Vb to the expansion voltage Va and then returning the voltage to the intermediate voltage Vb after a certain time elapses to expand the pressure chamber 26, the auxiliary contraction element PD which is a pulse waveform for increasing the voltage from the intermediate voltage Vb to an auxiliary contraction voltage Vd higher than the expansion voltage Va and the intermediate voltage Vb to slightly vibrate the pressure chamber 26 and then returning the voltage to the intermediate voltage Vb after a certain time elapses, the steady element PB for maintaining the intermediate voltage Vb for a certain time, and the contraction element PC which is a pulse waveform for increasing the voltage to the contraction voltage Vc higher than the expansion voltage Va and the intermediate voltage Vb to contract the pressure chamber 26 and then returning the voltage to the intermediate voltage Vb again. For example, the intermediate voltage Vb is 0 V. Here, a contraction amount of the auxiliary contraction element PD is smaller than a contraction amount of the contraction element PC. For example, the auxiliary contraction voltage Vd is smaller than the contraction voltage Vc and is about 1/2 of the contraction voltage Vc. For example, although the start of the auxiliary contraction element PD is after the expansion element PA, for example, after the voltage is returned to the intermediate voltage Vb from the expansion voltage, the voltage may be increased to the auxiliary contraction voltage Vd after a certain time elapses in the state of Vb.

The final drop waveform WB is obtained by adding a pulse that contracts by about half of the contraction element PC immediately after the end of the expansion state, at a steady state timing provided between the expansion and contraction of the standard drop waveform WA. A pulse width of the expansion element PA in the final drop waveform WB is set to an acoustic length (AL), which is half the natural vibration period of the pressure chamber 26 of the liquid ejection head 1.

As an example, the final drop waveform WB is a step waveform for increasing or decreasing the voltage in stages when increasing and decreasing the voltage during expansion and contraction, but is not limited thereto, and may be a waveform for increasing or decreasing the voltage at one time.

As illustrated in FIG. 4, the leading drop waveform WC includes the expansion element PA which is a pulse waveform for ejecting ink by decreasing the voltage from the intermediate voltage Vb to the expansion voltage Va to expand the pressure chamber 26 and then returning the voltage to the intermediate voltage Vb after a certain time elapses, the steady element PB for maintaining the intermediate voltage Vb for a certain time, and the contraction element PC which is a pulse waveform for increasing the voltage from the intermediate voltage Vb to the contraction voltage Vc higher than the expansion voltage Va and the intermediate voltage Vb to contract the pressure chamber 26 and then returning the voltage to the intermediate voltage Vb again. For example, the intermediate voltage Vb is 0 V.

The leading drop waveform WC is formed such that a width of the contraction waveform portion is longer than those of the standard drop waveform WA and the final drop waveform WB.

The steady waveform portion between the first leading drop waveform WC and the second standard drop waveform WA and the steady waveform portion between the last final drop waveform WB and the standard drop waveform WA before the final drop waveform WB are longer than the steady waveform portions between the other standard drop waveforms WA.

In the drive waveform according to the present embodiment, the plurality of drop waveforms are disposed end-to-end (or in a rear-justified manner) with a position of an end point of each ejection waveform portion as a reference. Here, the drive method according to the present embodiment is a so-called three-division drive in which a plurality of nozzles are driven sequentially in a group of three adjacent nozzles. For example, drive timing in a drive method in which nozzles are driven by the three-division drive will be described.

In the multi-drop waveform of the present embodiment, a time of the plurality of drop waveforms is constant. All pulse widths in the expansion state are set to AL. In the multi-drop waveform of the present embodiment, a width of the steady portion of each waveform portion is set such that a width between a center of an expansion pulse and a center of a contraction pulse is 2AL. By setting the width between the center of the expansion pulse and the center of the contraction pulse to 2AL, residual vibration of each waveform portion is reduced. The width may be set to minimize residual vibration according to ink to be used, and the width between the center of the expansion pulse and the center of the contraction pulse is not limited to 2AL.

The one or the plurality of drop waveforms in the drive waveform according to the present embodiment are disposed with a final drop waveform as a reference. That is, as illustrated in FIG. 3, with a drive waveform W5 for five drops being the maximum number of drops as a reference, for 4 or less drops, the drop waveforms are disposed end-to-end such that end timing of the final drop waveform in each drop waveform is the same for all the drop waveforms.

Here, an ejection waveform for n drops is a waveform obtained by removing a leading drop waveform from an ejection waveform for n+1 drops. That is, the drive waveform W4 for ejecting four drops is a waveform obtained by removing one leading drop waveform WC from the drive waveform W5 for five drops, where the leading drop waveform WC is a head of the drive waveform W5. The drive waveform W3 for three drops is a waveform obtained by removing one standard drop waveform WA from the drive waveform W4, where the standard drop waveform WA is a head of the drive waveform W4. The drive waveform W2 for two drops is a waveform obtained by removing one standard drop waveform WA from the drive waveform W3, where the standard drop waveform WA is a head of the drive waveform W3, and the drive waveform W1 for one drop is a waveform obtained by subtracting one standard drop waveform WA from the drive waveform W2, where the standard drop waveform WA is a head of the drive waveform W2, that is, the drive waveform W1 is the final drop waveform WB.

The drive timing and the landing accuracy of the drive waveform according to the present embodiment will be described with reference to Comparative Example 1.

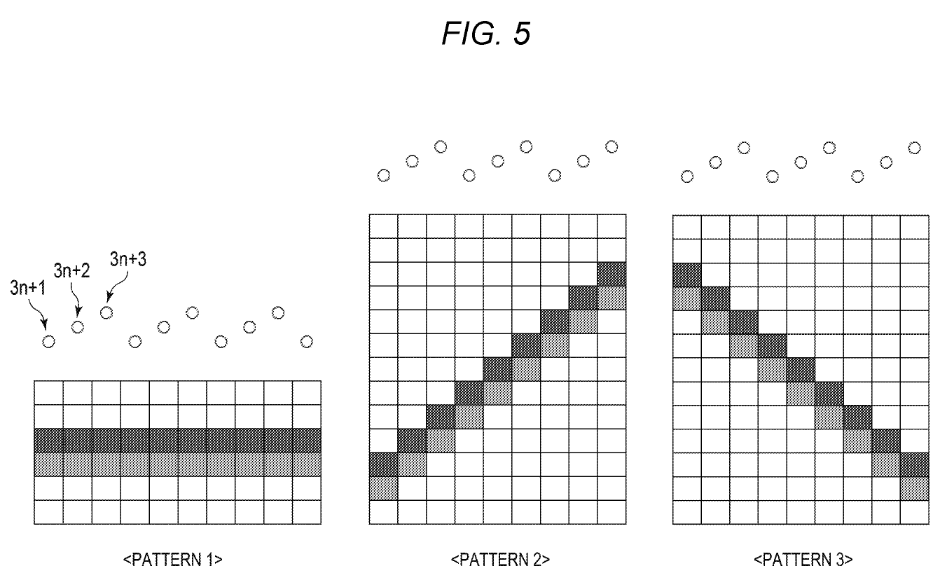

For example, regarding a control method for setting, using a three-division drive inkjet, an energization waveform for each gradation such that output timing of the energization waveform for final ink droplet ejection is synchronized, a case where printing is performed using three types of print patterns 1, 2, and 3 illustrated in FIG. 5 is considered.

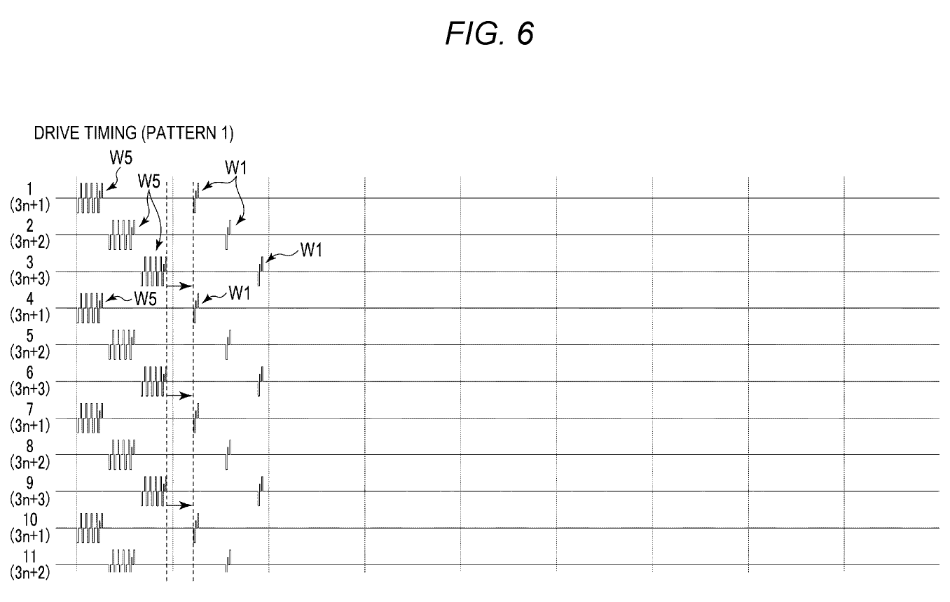

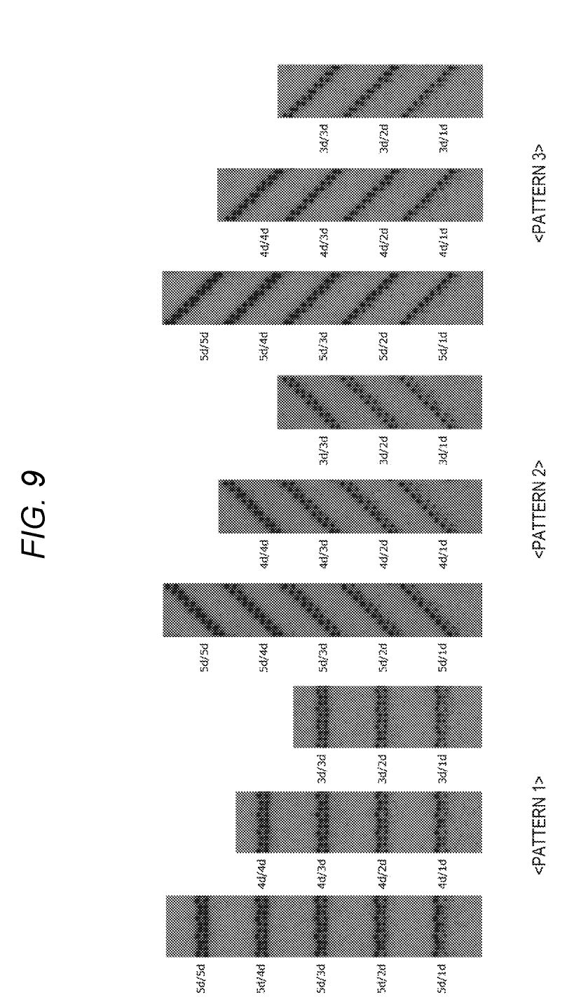

FIG. 5 is a diagram illustrating an example of a plurality of print patterns 1, 2, and 3. FIGS. 6-8 are diagrams illustrating drive waveforms when printing the print patterns 1, 2, and 3, respectively. FIG. 9 is a diagram illustrating a landing image formed by the liquid ejection head 1. Here, as illustrated in FIGS. 5-8, the drive method according to the present embodiment is a three-division drive in which the nozzles are divided into three groups, with three adjacent nozzles designated as 3n+1-th, 3n+2-th, and 3n+3-th nozzles, respectively, and driven sequentially. FIG. 9 illustrates, for each of the print patterns 1, 2, and 3, a case where one to five drops are separately ejected after ejecting five drops, a case where one to four drops are separately ejected after ejecting four drops, and a case where one to three drops are separately ejected after ejecting three drops.

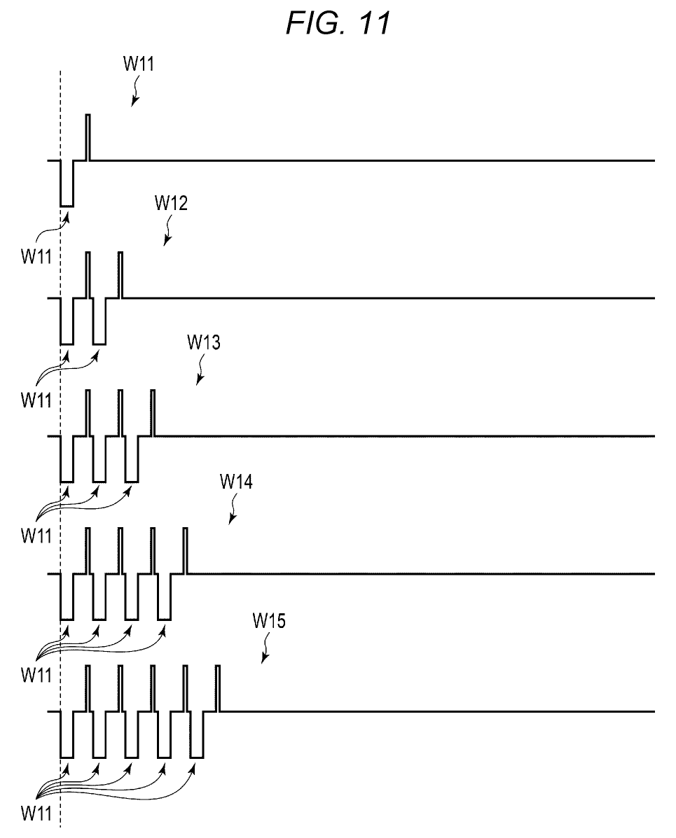

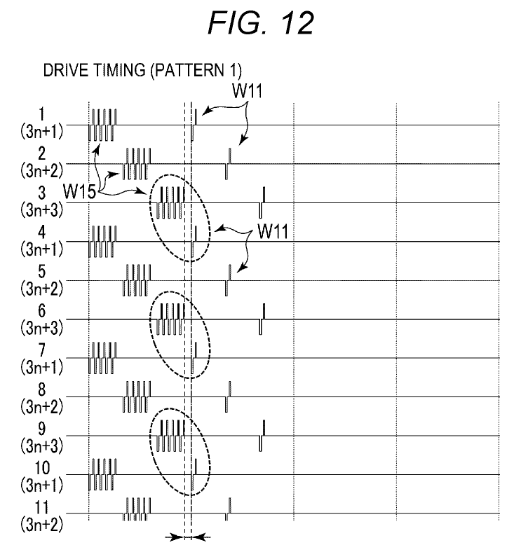

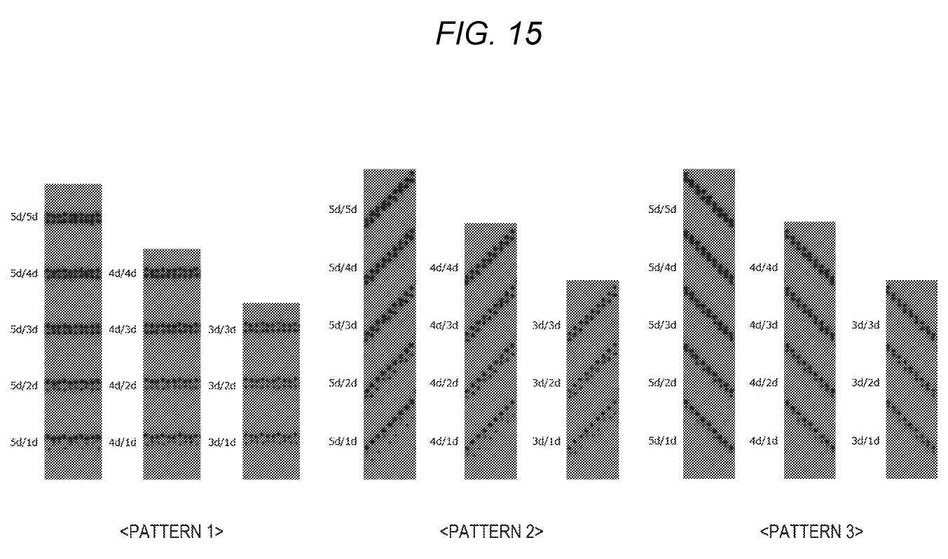

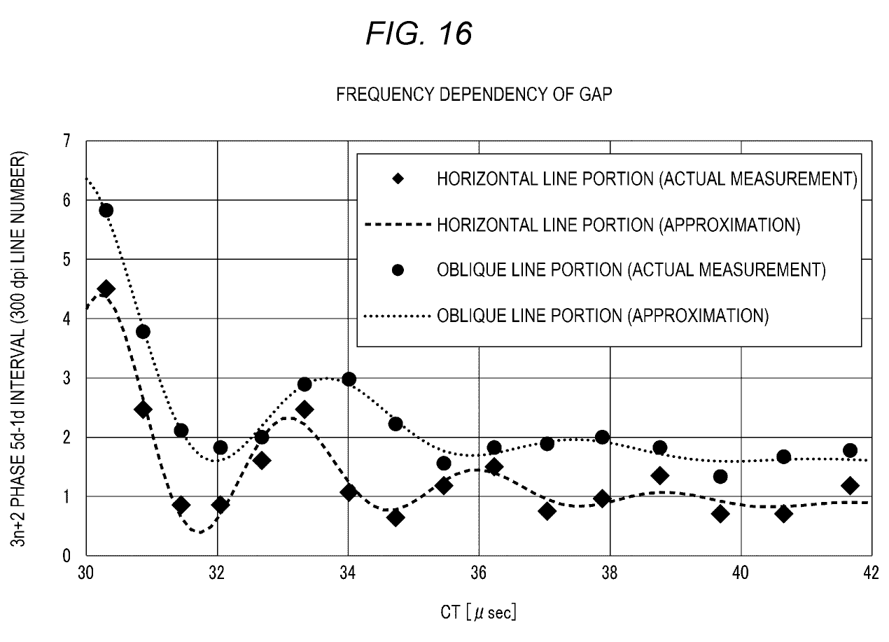

FIG. 11 is a diagram illustrating an example of drive waveforms of a plurality of drops in Comparative Example 1. FIGS. 12-14 are diagrams illustrating drive waveforms when printing the print patterns 1, 2, and 3 using a liquid ejection head according to Comparative Example 1, and FIG. 15 is a diagram illustrating a landing image formed by the liquid ejection head according to Comparative Example 1. FIG. 16 is a diagram illustrating frequency dependence in a multi-drop waveform according to Comparative Example 1. FIG. 15 illustrates, for each of the print patterns 1, 2, and 3, a case where one to five drops are separately ejected after ejecting five drops, a case where one to four drops are separately ejected after ejecting four drops, and a case where one to three drops are separately ejected after ejecting three drops.

Here, first, as Comparative Example 1, an example will be described in which control is performed such that first leading droplets for each gradation coincide with each other. As illustrated in FIG. 11, Comparative Example 1 is an example of a so-called front-justified disposition, and the disposition is performed such that timing of the first one drop for ejecting all drops is the same. That is, as illustrated in FIG. 11, a waveform is obtained by, with a drive waveform W11 for ejecting one drop as a reference, repeating the drive waveform W11 for ejecting one drop in accordance with the number of drops as the number of drops increases. That is, a drive waveform W12 for ejecting two drops is a waveform obtained by repeating two drive waveforms W11, a drive waveform W13 for ejecting three drops is a waveform obtained by repeating three drive waveforms W11, a drive waveform W14 for ejecting four drops is a waveform obtained by repeating four drive waveforms W11, and a drive waveform W15 for ejecting five drops is a waveform obtained by repeating five drive waveforms W11.

Regarding the drive waveform in Comparative Example 1, as illustrated in the diagram of the drive timing in FIG. 12 and the landing image in FIG. 15, it can be seen that in pattern 1, in a 3n+1 phase, a time interval from ejecting the maximum number of drops to ejecting a lower number of drops is small, and landing deviation occurs. On the other hand, in 3n+2 and 3n+3 phases, a time interval from ejecting the maximum number of drops to ejecting a lower number of drops is large, and no landing deviation occurs.

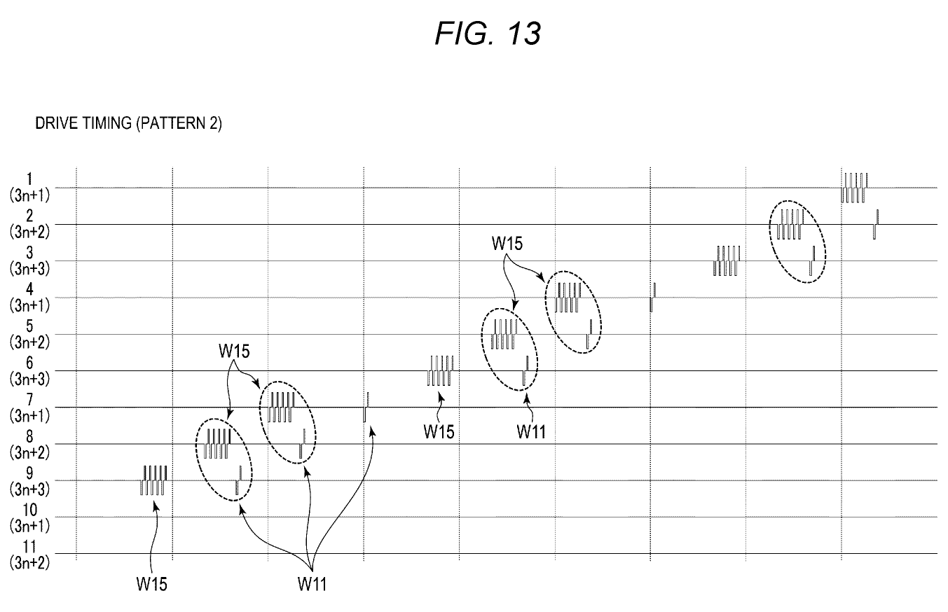

Regarding the drive waveform in Comparative Example 1, as illustrated in the diagram of the drive timing in FIG. 13 and the landing image in FIG. 15, it can be seen that in pattern 2, a time interval from ejecting the maximum number of drops to ejecting a lower number of drops is small, and in the 3n+2 and 3n+3 phases, the landing deviation occurs. On the other hand, no landing deviation occurs in the 3n+1 phase.

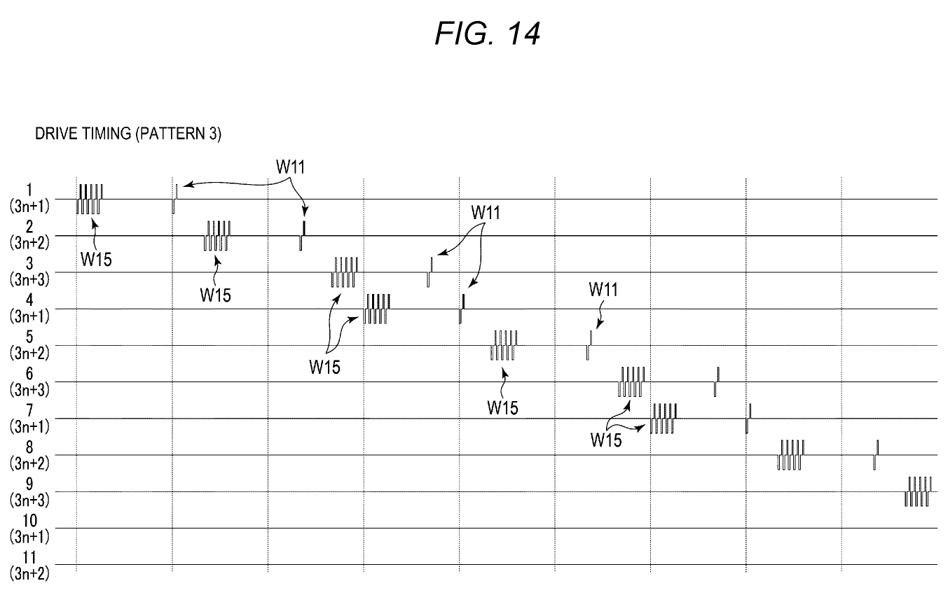

In pattern 3, as illustrated in the diagram of the drive timing in FIG. 14 and the landing image in FIG. 15, in any phase, a time interval from ejecting the maximum number of drops to ejecting a lower number of drops can be secured, and no landing deviation occurs.

On the other hand, regarding the drive waveform in the first embodiment, as illustrated in the diagram of the drive timing in FIGS. 6-8 and the landing image in FIG. 9, it can be seen that in any one of the patterns 1, 2, and 3, in the 3n+1, 3n+2, and 3n+3 phases, a time interval from ejecting the maximum number of drops to ejecting a lower number of drops can be secured, and no landing deviation occurs.

Here, if the landing deviation occurs, it can be seen that the larger the number of drops to be ejected first and further, the smaller the number of drops to be ejected next, the larger the deviation amount of the landing deviation. The reason for this is considered as follows. That is, if the inkjet head is driven at a high speed or a large droplet is ejected, a meniscus of the nozzle that ejects the droplet and the adjacent surrounding nozzles bulge in an ejection direction immediately after the ejection. If the droplet is ejected with a bulged meniscus, an ejection speed decreases compared to when ejection is performed with the meniscus not bulged.

Therefore, in a control method such as Comparative Example 1, where the energization waveforms for each gradation are set such that the output timing of the energization waveforms for the first ink droplet ejection is synchronized, the first drop is most affected by the bulged meniscus. Therefore, the ejection speed of a low-drop droplet immediately after a high-drop ejection is reduced, and thus the landing position is significantly shifted.

Here, in FIGS. 12-14, as illustrated by a temporal change of the drive waveform for each actual pattern, it can be seen that the nozzle in each of the patterns with a landing delay is one that performs ejection immediately after an adjacent nozzle ejects the maximum-sized droplet. On the other hand, in pattern 3 where no landing deviation occurs, it also can be seen that a time interval from ejecting the maximum number of drops to ejecting a lower number of drops is large. The most effective method for preventing the bulging of the meniscus, which causes such landing deviation, is to wait a certain amount of time after the ejection operation.

FIG. 16 is a graph illustrating a change in deviation amount when the frequency is changed. FIG. 16 corresponds to the landing image in Comparative Example 1 illustrated in FIG. 15, and illustrates an interval between five drops and one drop in the 3n+2 phase, which are shifted in position in a conveyance direction. A horizontal line portion indicates the pattern 1, and an oblique line portion indicates the pattern 2. In FIG. 16, actually measured plotted points are ones for which intervals are actually measured, and the points are fitted with a damped vibration function to show an approximation. According to the graph in FIG. 16, it can be seen that all patterns vibrate depending on CT (reciprocal of frequency). In FIG. 16, the larger the size in the vertical axial direction of the graph, the larger the amount of positional deviation, the shorter the CT (the higher the frequency), the larger the deviation amount, and the longer the CT (the lower the frequency), the smaller the deviation amount. It is preferable to use in an area where the deviation amount is small, but since there is a periodic change, there are restrictions such as only being usable for a specific time (for example, when CT is 32 μs) or only being usable in an area where CT is large (36 μs or more). Here, slowing down the frequency is equivalent to lengthening the time interval between these ejection operations, that is, the time difference between when an adjacent nozzle is driven and when the nozzle in question ejects. Therefore, it can be seen that meniscus bulging, which leads to a decrease in the ejection speed, can be prevented by increasing a pause time after the adjacent nozzle finishes driving. However, securing a long pause time corresponds to reducing the frequency, which makes it difficult to perform printing in a high frequency state.

According to the drive device and the drive method of the inkjet head according to the present embodiment, the drive waveforms of the respective drops are disposed end-to-end with the end timing of the final drop waveform for each gradation as a reference, and thus the landing accuracy can be improved. That is, in order to prevent the landing deviation even at a high frequency, by controlling the output timing of the drive waveform for ejecting the final droplet for each gradation such that the timing of the final droplet is synchronized, a state can be maintained in which the frequency is locally low in the time from immediately after the maximum-drop is ejected by the adjacent nozzle until the low-drop is ejected, and thus the ejection speed of the low drop can be increased.

According to the drive device and the drive method of the inkjet head according to the present embodiment, since the contraction pulse width of the waveform for ejecting the first droplet when ejecting the maximum number of drops is set to be longer than that of the other drops, the ejection volume can be increased even at the same voltage, and thus the power consumption can be reduced. In the drive waveform according to the present embodiment, the landing accuracy can be improved by providing a pulse in which the drive waveform for ejecting the final droplet has a contraction amount of half between expansion and steady.

Further, by setting the time interval between the drive waveform for ejecting the first droplet and the drive waveform for ejecting the second droplet, and the time interval between the waveform for ejecting the droplet immediately before the final droplet and the waveform for ejecting the final droplet to be longer than the time difference between the other droplets, the ejection speed of the first droplet is intentionally reduced, and ink dripping can be mainly prevented and the power consumption can be reduced.

The droplets between the first and last function by gradually reducing the ejection speed from the first drop, and the final droplet can achieve improved landing accuracy. The print quality can be improved by combining such waveforms end-to-end.

The time interval between the leading drop waveform WC for ejecting the first droplet and the standard drop waveform WA for ejecting the second droplet may be short. That is, similar to the time interval between the second drop and the third drop or between the third drop and the fourth drop, a waveform in which the time interval between the first drop and the second drop is short and the time interval between the fourth drop and the fifth drop is long may be used.

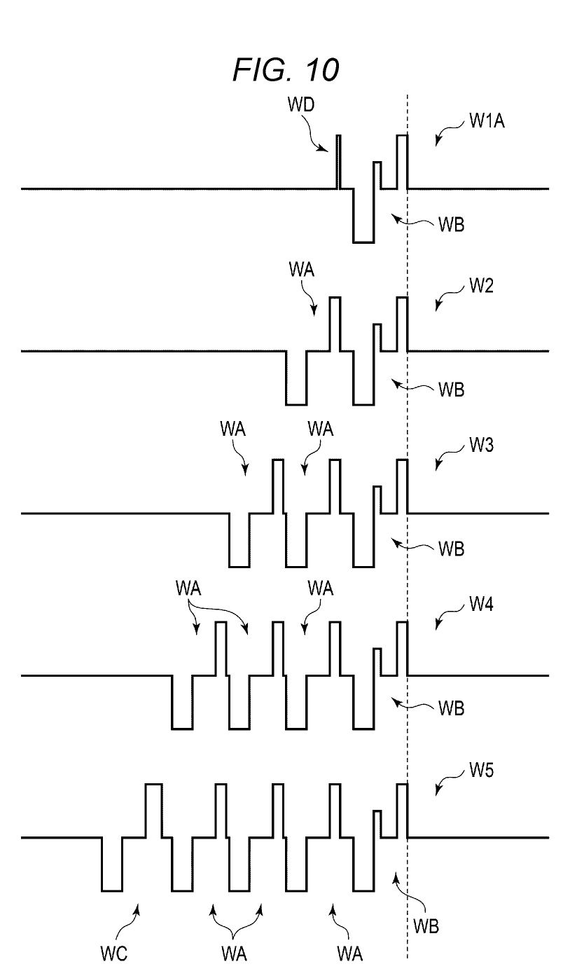

For example, as illustrated in FIG. 10 as another embodiment, a waveform obtained by first adding a non-ejection pulse WD may be used as a drive waveform W1A for ejecting one drop. In the present embodiment, the drive waveform W1A for ejecting one drop includes the non-ejection pulse WD, which is a non-ejection contraction pulse, before the final drop waveform WB. The other drive waveforms for ejecting two or more drops are the same as the drive waveforms W2, W3, W4, and W5 in the first embodiment. For example, in the multi-drop drive, the ejection speed tends to be low if ejecting only one drop, but according to the present embodiment, if ejecting only one drop, the ejection speed can be increased by adding the non-ejection pulse WD immediately before the final drop waveform.

Although one embodiment according to the present disclosure has been described in detail above, the present disclosure is not limited to the above-described embodiment, and modifications, improvements, and the like can be made as appropriate.

For example, the above embodiment is an example in which the maximum number of drops is five, but even if the maximum number of drops is four or less, or six or more, the control of the drive waveform for ejecting the first and last droplets when ejecting the maximum number of drops can be the same.

Specific conditions of the standard drop waveform, the final drop waveform, and the leading drop waveform are not limited to the above embodiments. In addition, a voltage value applied to each piezoelectric element can be appropriately adjusted according to various conditions. For example, a potential difference may be generated by grounding one of adjacent piezoelectric elements and applying a voltage to the other piezoelectric element, or a potential difference may be generated by applying voltages to both of the adjacent piezoelectric elements.

The drive waveform is not limited to a pull-shooting waveform, but may be a push-shooting waveform or a push-pull-shooting waveform.

For example, the configuration of the liquid ejection head 1 is not limited to the example described above, and may be used in a head of another type. For example, the liquid ejection head may be configured to drive a liquid ejection unit by causing vibration of a vibration plate provided between the pressure chamber and the drive element unit by deforming the drive element unit.

The liquid ejection device 2 is exemplified as an inkjet printer that forms a two-dimensional image with ink on an image formation medium, but is not limited thereto, and may be, for example, a 3D printer, an industrial manufacturing machine, a medical machine, or the like, and may form a three-dimensional object by ejecting, for example, a material substance or a binder for solidifying the material from an inkjet head.

Further, in the above embodiments, an example of the control operation of the control unit 2118 has been described, but the present disclosure is not limited thereto. For example, the liquid ejection head 1 may be provided with a drive circuit for driving an actuator, and the liquid ejection head 1 itself may serve as a drive device, or may be equipped with a drive device.

According to at least one of the embodiments described above, differences in ejection speed of a plurality of drops can be reduced by combining the final drop waveform WB including the auxiliary contraction element PD after expansion in the drive waveform and reducing the contraction amount of the auxiliary contraction element PD for the later drops.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying embodiments and their equivalents are intended to cover such forms or modifications as would fall within the scope and spirit of the disclosure.

What is claimed is:

1. A driving device for a liquid ejection head including an actuator configured to eject liquid stored in a pressure chamber through a nozzle, the driving device comprising:
a drive circuit configured to generate a drive signal for the actuator of the liquid ejection head, the drive signal including one or more drop waveforms for ejecting one or more droplets of the liquid through the nozzle, wherein
the drive circuit is further configured to arrange the one or more drop waveforms in a rear-justified manner such that an end timing of a final drop waveform is the same among drive waveforms for ejecting different numbers of droplets.

2. The driving device according to claim 1, wherein drop waveforms for ejecting n droplets are obtained by removing a leading drop waveform from drop waveforms for ejecting n+1 droplets.

3. The driving device according to claim 1, wherein in drop waveforms for ejecting three or more droplets, a first drop waveform and a last drop waveform have a characteristic different from that of an intermediate drop waveform.

4. The driving device according to claim 1, wherein
each of the one or more drop waveforms includes an expansion waveform portion for expanding the pressure chamber, a steady waveform portion, and a contraction waveform portion for contracting the pressure chamber, and
a width of the contraction waveform portion of a first drop waveform is longer than a width of the contraction waveform portion of another drop waveform.

5. The driving device according to claim 1, wherein
a final drop waveform of the one or more drop waveforms includes an expansion waveform portion for expanding the pressure chamber, a first contraction waveform portion for contracting the pressure chamber, a steady waveform portion, and a second contraction waveform portion for contracting the pressure chamber, and
a contraction amount of the pressure chamber by the first contraction waveform portion is smaller than a contraction amount of the pressure chamber by the second contraction waveform portion.

6. The driving device according to claim 1, wherein
a steady waveform portion between a first drop waveform and a second drop waveform and a steady waveform portion between a last drop waveform and a drop waveform immediately before the last drop waveform are longer than a steady waveform portion between other drop waveforms.

7. The driving device according to claim 1, wherein
each of the one or more drop waveforms includes an expansion waveform portion for expanding the pressure chamber, and
a pulse width of the expansion waveform portion is an acoustic length (AL) which is half a natural vibration period of the pressure chamber.

8. The driving device according to claim 1, wherein each of the one or more drop waveforms includes an expansion waveform portion for expanding the pressure chamber and a contraction waveform portion for contracting the pressure chamber, and
a time width between a center of the expansion waveform portion and a center of the contraction waveform portion is set to 2AL, where AL is an acoustic length which is half a natural vibration period of the pressure chamber.

9. The driving device according to claim 1, wherein the drive signal for ejecting a single droplet includes a non-ejection pulse for contracting the pressure chamber without ejecting the liquid before a drop waveform.

10. The driving device according to claim 1, wherein the liquid ejection head includes a plurality of nozzles, and the drive circuit is configured to drive the plurality of nozzles by sequentially driving adjacent nozzles in groups of three.

11. A liquid ejection head comprising:
an actuator configured to eject liquid stored in a pressure chamber through a nozzle; and
a drive circuit configured to generate a drive signal for the actuator, the drive signal including one or more drop waveforms for ejecting one or more droplets of the liquid through the nozzle, wherein
the drive circuit is further configured to arrange the one or more drop waveforms in a rear-justified manner such that an end timing of a final drop waveform is the same among drive waveforms for ejecting different numbers of droplets.

12. The liquid ejection head according to claim 11, wherein drop waveforms for ejecting n droplets are obtained by removing a leading drop waveform from drop waveforms for ejecting n+1 droplets.

13. The liquid ejection head according to claim 11, wherein in drop waveforms for ejecting three or more droplets, a first drop waveform and a last drop waveform have a characteristic different from that of an intermediate drop waveform.

14. The liquid ejection head according to claim 11, wherein
each of the one or more drop waveforms includes an expansion waveform portion for expanding the pressure chamber, a steady waveform portion, and a contraction waveform portion for contracting the pressure chamber, and
a width of the contraction waveform portion of a first drop waveform is longer than a width of the contraction waveform portion of another drop waveform.

15. The liquid ejection head according to claim 11, wherein
a final drop waveform of the one or more drop waveforms includes an expansion waveform portion for expanding the pressure chamber, a first contraction waveform portion for contracting the pressure chamber, a steady waveform portion, and a second contraction waveform portion for contracting the pressure chamber, and
a contraction amount of the pressure chamber by the first contraction waveform is smaller than a contraction amount of the pressure chamber by the second contraction waveform.

16. The liquid ejection head according to claim 11, wherein a steady waveform portion between a first drop waveform and a second drop waveform and a steady waveform portion between a last drop waveform and a drop waveform immediately before the last drop waveform are longer than a steady waveform portion between other drop waveforms.

17. The liquid ejection head according to claim 11, wherein
each of the one or more drop waveforms includes an expansion waveform portion for expanding the pressure chamber, and
a pulse width of the expansion waveform portion is an acoustic length (AL) which is half a natural vibration period of the pressure chamber.

18. The liquid ejection head according to claim 11, wherein
each of the one or more drop waveforms includes an expansion waveform portion for expanding the pressure chamber and a contraction waveform portion for contracting the pressure chamber, and
a time width between a center of the expansion waveform portion and a center of the contraction waveform portion is set to 2AL, where AL is an acoustic length which is half a natural vibration period of the pressure chamber.

19. The liquid ejection head according to claim 11, wherein the drive signal for ejecting a single droplet includes a non-ejection pulse for contracting the pressure chamber without ejecting the liquid before a drop waveform.

20. A liquid ejection device comprising:
a liquid ejection head for ejecting liquid onto a medium; and
a controller configured to control the liquid ejection head, wherein
the liquid ejection head includes:
an actuator configured to eject the liquid stored in a pressure chamber through a nozzle, and
a drive circuit configured to generate a drive signal for the actuator, the drive signal including one or more drop waveforms for ejecting one or more droplets of the liquid through the nozzle, and
the drive circuit is further configured to arrange the one or more drop waveforms in a rear-justified manner such that an end timing of a final drop waveform is the same among drive waveforms for ejecting different numbers of droplets.
